(19) United States
(12) Patent Application Publication
(10) Pub. No.: US 2009/0013498 A1
(43) Pub. Date: Jan. 15, 2009

(54) Hinge Assembly

(76) Inventor: Jr-Jiun Chern, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/775,927

(22) Filed: Jul. 11, 2007

(51) Int. Cl. E05D 11/00

(52) U.S. Cl. 16/223

(57) ABSTRACT

A hinge assembly includes a body having a housing. A plug is disposed and locked inside said housing. A resilient sleeve is received in said plug. The resilient sleeve includes a first portion having two first peripheral surfaces and a second peripheral surface and a second portion disposed therebetween. The first portion is attached to the second portion at the two first peripheral surfaces and defines a frictional hole and two gaps therebetween. Each of the gaps allows the first portion to be stretchably bonded with the second portion. A pintle includes a pivoting portion being disposed in the frictional hole. The pivoting portion includes two curved surfaces and two flat surfaces formed thereon, wherein one of the flat surfaces is positioned correspondingly to the second peripheral surface, and one of the flat surfaces corresponds to the second portion.

### BACKGROUND OF THE INVENTION

1. Field of the Invention

The present invention relates to a hinge assembly, more particularly to a hinge assembly for a portable computer.

2. Description of the Related Art

Generally speaking, when opening a portable computer a user has to engage one hand to hold a base while using the other hand to pivot a display about a hinge assembly if the frictional force is so great. Furthermore, the hinge assembly has a tendency to fail to hold the display at an angle relative to the base preferred by the user when the hinge assembly gets fatigued.

Referring to Taiwan Pat. No. M288490, a flat spring hinge 20 made of metal is provided to a portable computer. The flat spring hinge 20 includes a cylindrical wall 23 wrapping at least substantially circumferentially around the longitudinal portion of a pintle 22. The interaction between the pintle 22 and the flat spring hinge 20 provides lower frictional force when opening the portable computer than that when closing it. However, the flat spring hinge 20 often gets fatigued and no longer provides as much resistive force as necessary to allow the user to fully open the portable computer easily and to make the display open to a desired position after a repetitive use.

The present invention is, therefore, intended to obviate or at least alleviate the problems encountered in the prior art.

### SUMMARY OF THE INVENTION

A hinge assembly includes a body having a mounting tab connectable to a portable computer and a housing. A plug is disposed and locked inside said housing such that said plug is not rotatable relative to the housing. A resilient sleeve is received in said plug. The resilient sleeve includes a first portion having two first peripheral surfaces and a second peripheral surface and a second portion disposed therebetween. The first portion is attached to the second portion at the two first peripheral surfaces and defines a frictional hole and two gaps therebetween. Each of the gaps allows the first portion to be stretchably bonded with said second portion. A pintle includes a mounting portion connectable to the portable computer and a pivoting portion being disposed in the frictional hole. The pivoting portion includes two curved surfaces and two flat surfaces formed thereon, wherein one of the flat surfaces is positioned correspondingly to the second peripheral surface, and one of the flat surfaces corresponds to the second portion. A position limiting member includes a though hole which allows insertion of the pivoting portion of the pintle and a ledge abutting against a planar surface formed on an end of the mounting tab which connects to an end of the pivoting portion. As the ledge is locked to the mounting tab, the position limiting member can rotate in response to the turning of the pintle. In addition, the position limiting member has a pair of radially extended protrusions. Each protrusion can incorporate with the protuberance of the plug such that range of rotation of the pintle is limited between the pair of protrusion.

It is an objective of this invention that the interaction between the resilient sleeve and pintle provides a good frictional force to allow the portable computer remained firmly in a desired static position.

It is another objective of this invention that position limiting member is provided to limit the range of rotation of the pintle such that improper opening leading to the damage of the portable computer can be prevented.

Other objectives, advantages, and novel features of the invention will become more apparent from the following detailed description when taken in conjunction with the accompanying drawings.

### BRIEF DESCRIPTION OF THE DRAWINGS

FIG. 1 is a perspective view of a hinge assembly in accordance with the present invention.

FIG. 2 is an exploded perspective view of FIG. 1.

FIG. 3 is a cross-sectional view taken along line 3-3 of FIG. 1.

FIG. 4 is a cross-sectional view taken along line 4-4 of FIG. 1.

FIG. 5 is a cross-sectional view taken along line 5-5 of FIG. 1.

FIG. 6 is a cross-sectional view taken along line 6-6 of FIG. 1.

FIG. 7 is a diagrammatic view illustrating the operation of the hinge assembly.

FIG. 8 is a cross-sectional view illustrating the operation of the hinge assembly.

FIG. 9 is another cross-sectional view illustrating the operation of the hinge assembly.

### DETAILED DESCRIPTION OF THE PREFERRED EMBODIMENT

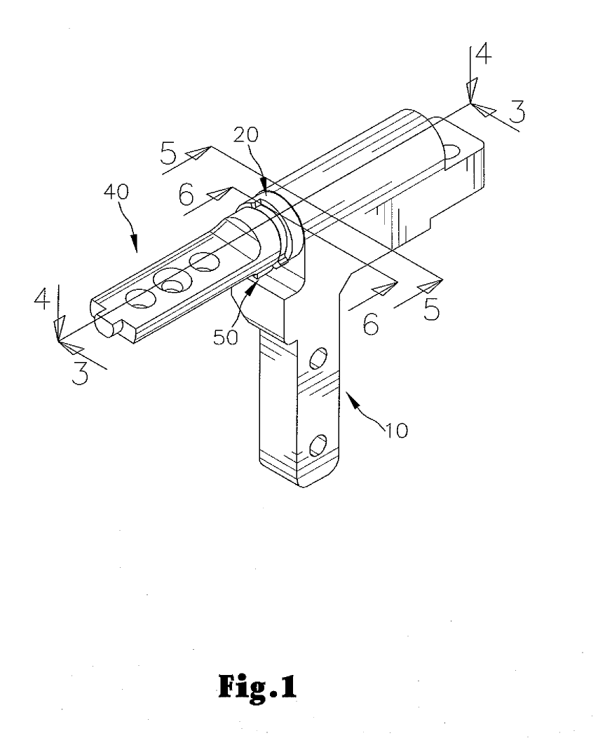

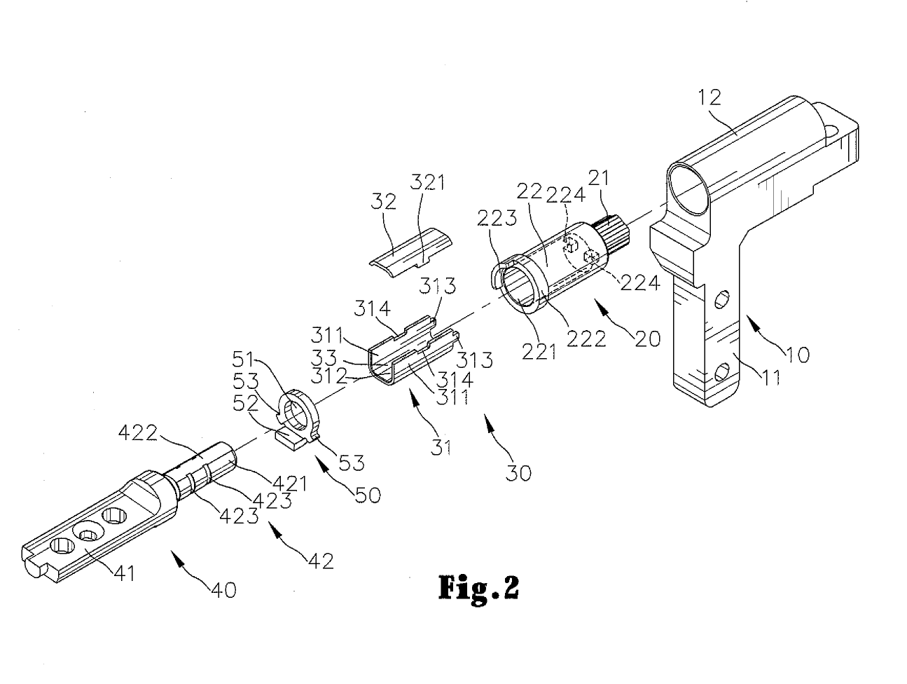

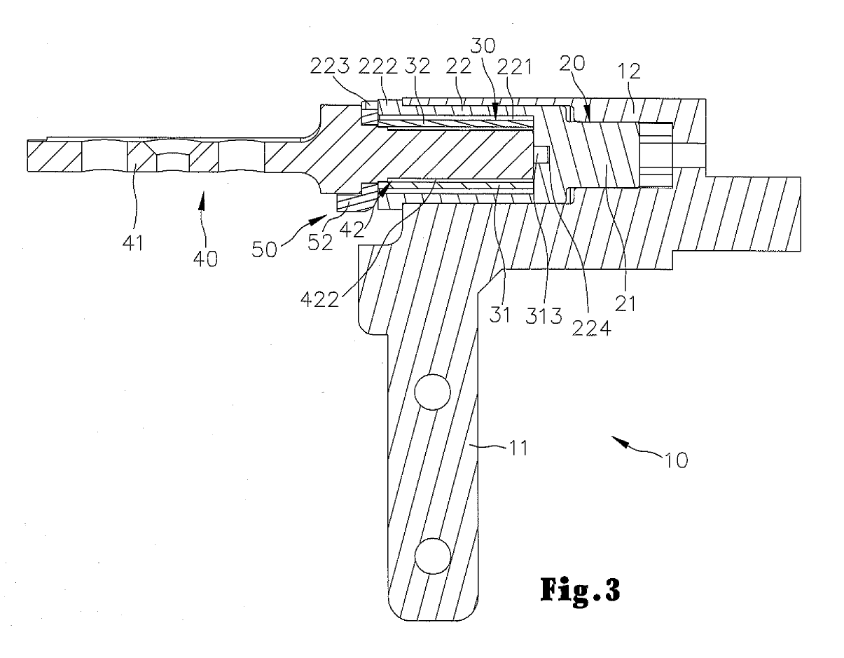

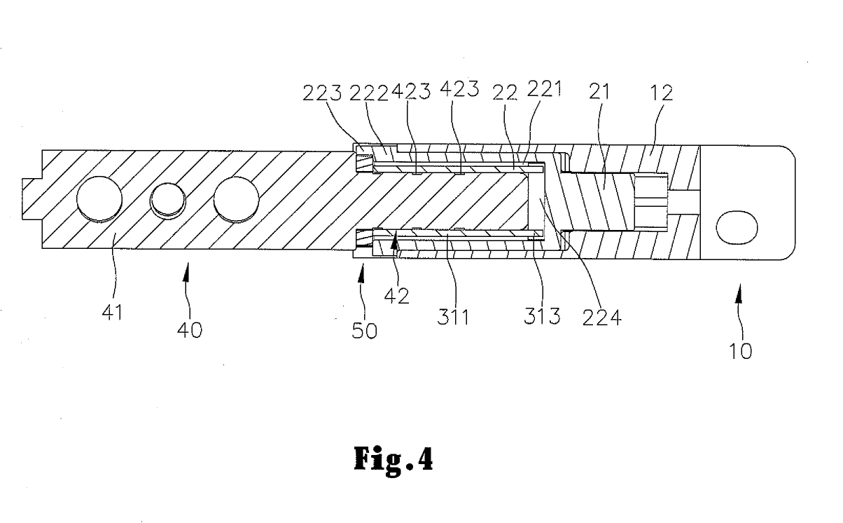

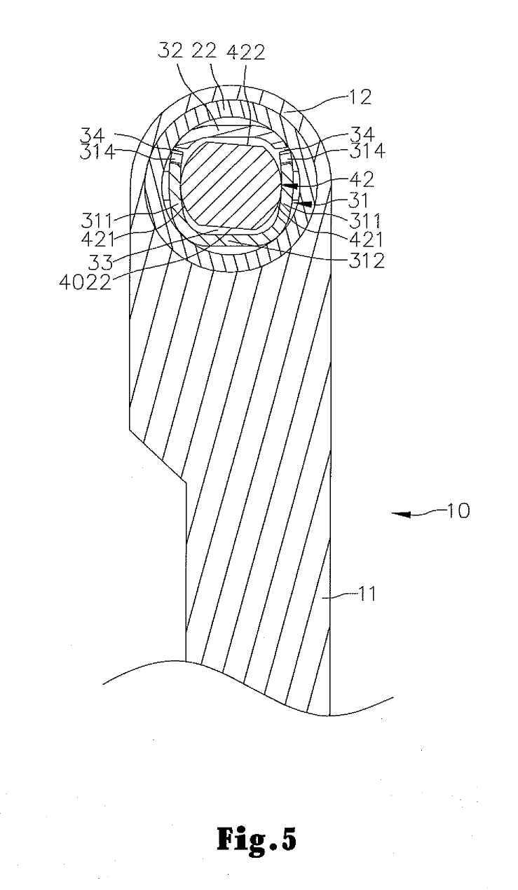

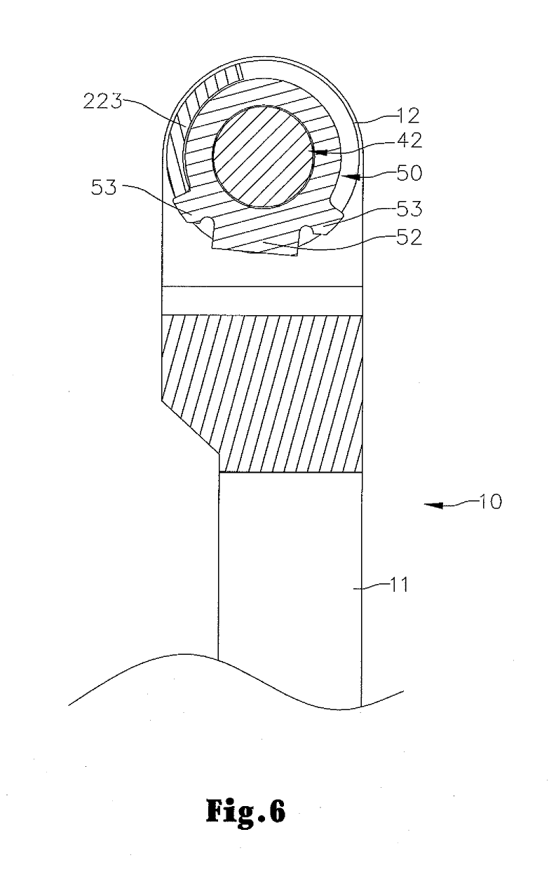

Referring to FIGS. 1 through 6, a hinge assembly in accordance with the present invention includes a body 10 having a mounting tab connectable to a portable computer and a housing 12 disposed at a right angle thereto. A plug 20 is installed and locked inside the housing 12 by a clutching portion 21 such that the plug 20 is not rotatable relative to the housing 12. The plug 20 also includes a receiving portion 22 connected to the clutching portion 21. The receiving portion 22 has a receptacle 221 which is adapted to receive a locking a resilient sleeve 30 and two indentations 224 which is adapted to lock and prevent the resilient sleeve 30 from rotating relative to the plug 20. In addition, the plug 22 has a flange 222 formed at a distal end thereof, near the opening of the receptacle 211. The flange 222 has a protuberance 223 formed thereof.

The resilient sleeve 30 is in substantially the shape of a quadrangle and includes a first portion 31 and a second portion 32 which may be manufactured by pressing. The first portion 31 is in the shape of the letter U and includes two first peripheral surfaces 311 and a second peripheral surface 312 disposed therebetween. Each first peripheral surface 311 includes a hooking portion 313 extending longitudinally therefrom for engagement in one of the indentations 224. Each first peripheral surface 311 also includes a recess 314 disposed approximately at the middle of a peripheral edge thereof. The recess 314 extends from the peripheral edge toward the second peripheral surface 312. In addition, the second portion 32 includes two engaging portions 321 extended from two different sides and disposed approximately at the middle thereof. Each of the engaging portions 321 fits complemently in one of the recess 314, and thereby the first portion 31 and second portion 32 are assembled together.

The resilient sleeve 30 also defines a frictional hole 33 which is adapted to receive a pintle 40 and two gaps 34 which allow the first portion 31 to be stretchably bonded with the second portion 32. Each of the gaps 34 extend longitudinally along the peripheral edge of the first peripheral surface 311 and disposed between the first portion 31 and second portion 32.

The pintle 40 includes a mounting tab 41 connectable to the portable computer and a pivoting portion 42 opposite thereto. The pivoting portion 42 is in the form of a shaft and includes a pair of oppositely disposed curved surface 421 and a pair of oppositely disposed flat surfaces 422. One of the flat surfaces 422 is positioned correspondingly to the second peripheral surface 312 of the resilient sleeve 30 while the other corresponds to the second portion 32 of the resilient sleeve 30. Furthermore, one of the pair of curved surface 421 abuts against one of the pair of first peripheral surface 311 respectively. The curved surfaces 421 are also adapted to support the pivoting portion 42 in the resilient sleeve 30 such that the flat surfaces 422 are not in contact with the second peripheral surface 312 or second portion 32 of the resilient sleeve 30. Further, the pivoting portion 42 includes a plurality of grooves 423 radially disposed on the pivoting portion 42. Each groove 423 is parallel to each other and adapted for retaining oil lubricant.

A position limiting member 50 includes a though hole 51 which allows insertion of the pivoting portion 42 of the pintle 40 and a ledge 52 abutting against a planar surface 411 formed on an end of the mounting tab 411 which connects to an end of the pivoting portion 42. As the ledge 52 is locked to the mounting tab 411, the position limiting member 50 can rotate in response to the turning of the pintle 40. In addition, the position limiting member 50 has a pair of radially extended protrusions 53. Each protrusion 53 can incorporate with the protuberance 223 of the plug 20 such that range of rotation of the pintle 40 is limited between the pair of protrusion 53.

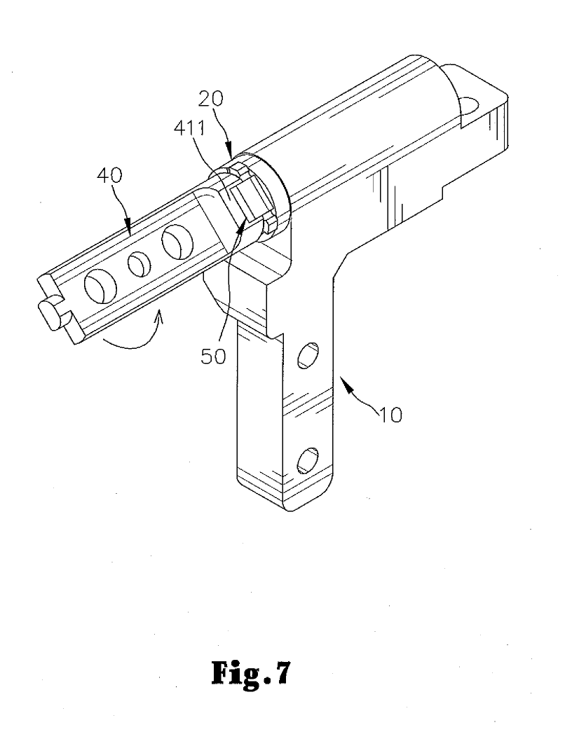

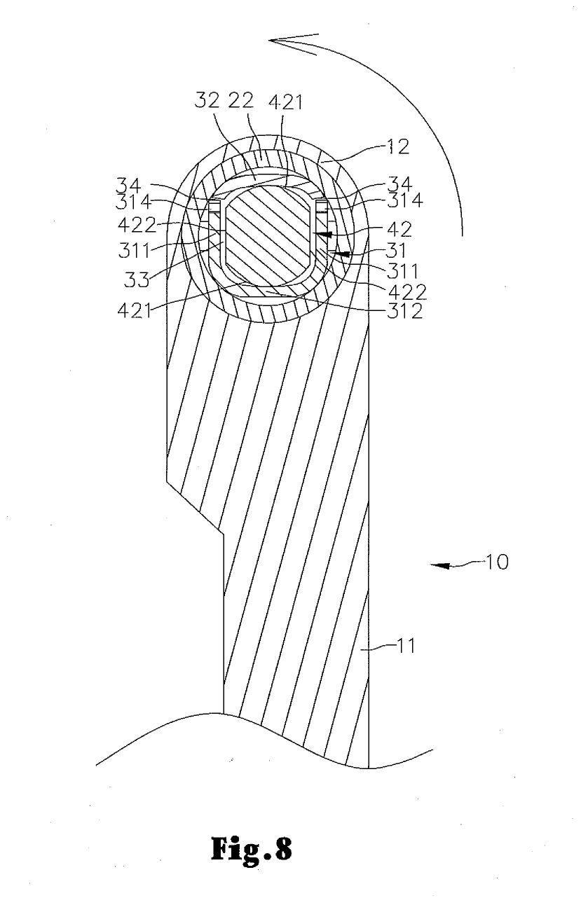

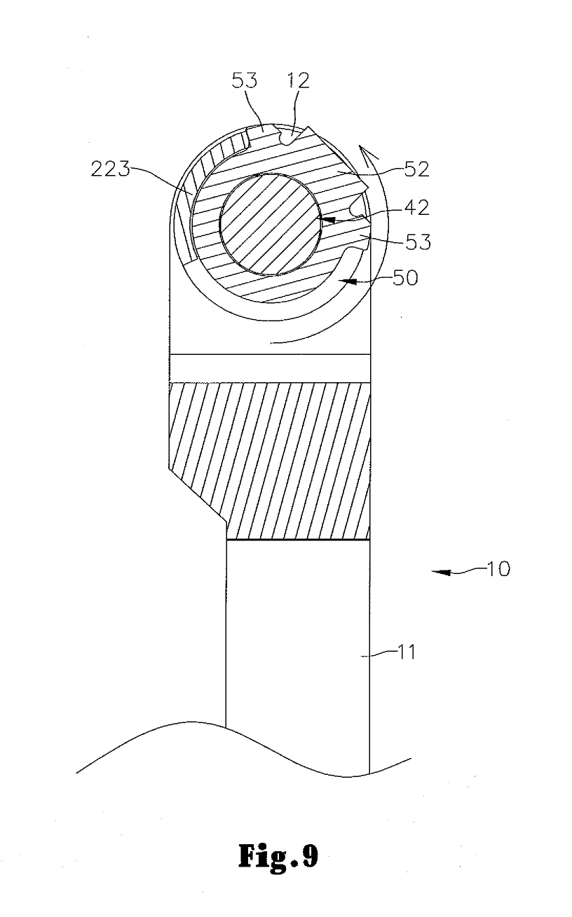

FIGS. 7 through 9 illustrate the operation of the hinge assembly. The hinge assembly allows a portable computer to be opened from 0 degree (closed position of the portable computer) to 10 degrees by a light force and to be closed from 135 degrees to 10 degrees by a bigger force. When rotating the pintle 40, the curved surfaces 421 of the pivoting portion 42 and the gaps 34 disposed between the first portion 31 and second portion 32 can facilitate easy rotation of the pintle 40. The pintle 40 can be rotated through an angle until, when another protrusion 53 is engaged with the protuberance 223. The second peripheral surface 312 and second portion 32 are abutted by the curved surfaces 421 respectively, and the resilient sleeve 30 is stretchably extensible by the curved surfaces 421.

Accordingly, it is one aspect of the present invention that the resilient sleeve 30 may be manufactured by pressing in order to save manufacturing costs.

As another aspect of the invention, the interaction between the resilient sleeve 30 and pintle 40 provides a good frictional force to allow the portable computer remained firmly in a desired static position.

As another aspect of the invention, the position limiting member 50 is provided to limit the range of rotation of the pintle 40 such that improper opening leading to the damage of the portable computer can be prevented.

While the specific embodiments have been illustrated and described, numerous modifications come to mind without significantly departing from the spirit of invention and the scope of invention is only limited by the scope of accompanying claims.

What is claimed is:

1. A hinge assembly comprising:
a body including a mounting tab connectable to a portable computer and a housing;
a plug being disposed and locked inside said housing such that said plug is not rotatable relative to the housing;
a resilient sleeve being received in said plug, with said resilient sleeve including a first portion and a second portion, with said first portion including two first peripheral surfaces and a second peripheral surface, with said first portion being attached to said second portion at said two first peripheral surfaces, with said first portion and second portion defining a frictional hole and two gaps therebetween, and with each said gap allowing said first portion to be stretchably bonded with said second portion;
a pintle including a mounting portion connectable to a portable computer and a pivoting portion, with said pivoting portion being disposed in said frictional hole, with said pivoting portion including two curved surfaces and two flat surfaces formed thereon; and
wherein one of said flat surfaces is positioned correspondingly to said second peripheral surface, and one of said flat surfaces corresponds to said second portion.

2. A hinge assembly as claimed in claim 1 wherein said first portion and second portion of said resilient sleeve are manufactured by pressing.

3. A hinge assembly as claimed in claim 1 wherein each said first peripheral surface includes a hooking portion extending longitudinally therefrom, and said plug includes two indentations, with each said indentation receivable by a hooking portion.

4. A hinge assembly as claimed in claim 1 wherein said first portion is in the shape of the letter U.

5. A hinge assembly as claimed in claim 1 wherein said frictional hole is in substantially the shape of a quadrangle.

6. A hinge assembly as claimed in claim 1 wherein each said first peripheral surface includes a recess extending from the peripheral edge thereof toward the second peripheral surface, and said second portion includes two engaging portion extending radially from two different sides, with each said engaging portion being engagable in one of said recess.

7. A hinge assembly as claimed in claim 1 further includes a position limiting member receivable by said pintle, and said plug includes a flange, with said flange incorporating with said position limiting member such that range of rotation of said pintle is limited.

8. A hinge assembly as claimed in claim 7 wherein said position limiting member includes two protrusion, and said plug includes a protuberance, with said protuberance incorporating with said two protrusion such that range of rotation of said pintle is limited.

9. A hinge assembly as claimed in claim 7 wherein said position limiting member includes a ledge lockable with said pintle.

10. A hinge assembly as claimed in claim 1 wherein said pintle includes a plurality of grooves radially disposed on said pivoting portion, with said grooves parallel to each other.
